(19) United States
(12) Patent Application Publication
(10) Pub. No.: US 2010/0026951 A1
(43) Pub. Date: Feb. 4, 2010

(54) CONNECTION STRUCTURE OF DISPLAY PANEL AND FLEXIBLE PRINTED CIRCUIT BOARD

(75) Inventors: Chia-Ming Chiang, Taoyuan County (TW); Meng-Chi Liou, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/235,541

(22) Filed: Sep. 22, 2008

(30) Foreign Application Priority Data
Aug. 1, 2008 (TW) 97129307

(51) Int. Cl. G02F 1/1345

(52) U.S. Cl. 349/150

(57) ABSTRACT

A connection structure of a display panel and a flexible printed circuit board is provided. The connection structure includes the display panel, the flexible printed circuit board, and an anisotropic conductive film. The display panel includes a plurality of contact pads. Each of the contact pads includes a first metal layer, a first insulation layer, a second metal layer and a second insulation layer. The flexible printed circuit board is disposed on the contact pads of the display panel. The anisotropic conductive film is disposed between the flexible printed circuit board and the contact pads. The anisotropic conductive film is in direct contact with the exposed first metal layers and second metal layers of the contact pads.

### CROSS-REFERENCE TO RELATED APPLICATION

This application claims the priority benefit of Taiwan application serial no. 97129307, filed on Aug. 1, 2008. The entirety of the above-mentioned patent application is hereby incorporated by reference herein and made a part of specification.

### BACKGROUND OF THE INVENTION

1. Field of the Invention

The present invention generally relates to a connection structure, and more particularly, to a connection structure of a display panel and a flexible printed circuit board.

2. Description of Related Art

As science and technology being developed, great improvements have been with respect to technologies for display devices, and accordingly the demand for display devices is drastically increasing. In the earlier days, cathode ray tube (CRT) displays presented outstanding displaying performance and mature techniques comparing with other kinds. Therefore, the CRT displays had almost exclusively occupied the display market for a very long period. However, the green concept of environmental protection has been paid with more attention, and therefore the CRT displays which consume a lot of energy, generate a large amount of radiation, and even often occupy a large 3D space, are now incapable of satisfying the trend of display devices, (e.g., being lighter, thinner, shorter, smaller, cuter, and lower power consumption), demanded by the current market. As such, flat panel displays (FPD) which are lighter and thinner now gradually displace the position of those bulky CRT displays in the market. Specifically, the most popular FDPs include plasma display panels (PDP), liquid crystal displays (LCD), and thin film transistor liquid crystal displays (TFT-LCD).

Nowadays, users often demand for a higher resolution than ever before for the displays, and in further consideration of trend of the electronic products (e.g., being lighter, thinner, shorter, smaller). The packaging technology for the driver IC of a display panel has been developed from a chip on board (COB) technology to a tape automated bonding (TAB) technology, and has been further developed to a fine pitch chip on glass (COG) technology. Conventionally, a typical COG technology is usually an application of a flip-chip (F/C) technology. In such a COG process, the fabrication of the protrusion on the chip and the assembly between the flexible printed circuit (FPC) and the LCD panel are specifically critical.

FIG. 1 is a schematic diagram illustrating a contact pad according to a conventional technology. Referring to FIG. 1, a contact pad 100 is disposed on a substrate 10 of a display. The contact pad 100 includes a first metal layer 102, a first insulation layer 104, a second metal layer 106, a second insulation layer 108, and a transparent electrode 110. The first insulation layer 104 is disposed on the first metal layer 102. The second metal layer 106 is disposed on the first insulation layer 104. The first metal layer 102 is electrically isolated from the second metal layer 106 by the first insulation layer 104. The second insulation layer 108 is disposed on the second metal layer 106. The transparent electrode 110 is disposed on the second insulation layer 108, covering a part of the first metal layer 102 and a part of the second metal layer 106.

FIG. 2A is a schematic diagram illustrating a flexible printed circuit board being pressed upon the contact pad as shown in FIG. 1. Referring to FIG. 2A, a flexible printed circuit board 12 is provided upright above the contact pad 100, and an anisotropic conductive film 14 is disposed between the flexible printed circuit board 12 and the contact pad 100. When being applied with a press force, the flexible printed circuit board 12 transfers the press force to the anisotropic conductive film 14, so that the anisotropic conductive film 14 is uniformly covered on the transparent electrode 110. In such a way, the transparent electrode 110, the first metal layer 102, and the second metal layer 106 are electrically connected one to another.

However, when the flexible printed circuit board 12 is pressed with a deviation on the contact pad 100, as shown in FIG. 2B, the anisotropic conductive film 14 correspondingly covers only a part of the transparent electrode 110. Generally, the flexible printed circuit board 12 is adapted to transmit current along a direction perpendicular to the anisotropic conductive film 14, and therefore the flexible printed circuit board 12 will only be electrically connected with the first metal layer 102 and the transparent electrode 110 which are covered by the anisotropic conductive film 14. As such, the second metal layer 106 at the right side of the contact pad 100 is not in contact with the anisotropic conductive film 14 as shown in FIG. 2B, and therefore a signal input condition of the first metal layer 102 and the second metal layer 106 is caused distinct from normal condition (e.g., the left side of the contact pad 100).

Further, according to the conventional technology, the second insulation layer 108, the first metal layer 102 and the second metal layer 106 are covered by the transparent electrode 110, and the transparent electrode 110 is made of a metal oxide having a resistivity higher than metal materials. As such, the connection structure often has a relatively high resistance. In this concern, it is very important to effectively decrease the signal input variance caused by deviation when pressing the flexible printed circuit board, and the contact resistance of the transparent electrode in a limited space, for improving the assembly of the display and the flexible printed circuit board.

### SUMMARY OF THE INVENTION

Accordingly, the present invention is directed to provide a connection structure of a display panel and a flexible printed circuit board. The connection structure is adapted for decreasing the signal input variance caused by the deviation when pressing the flexible printed circuit board and the contact resistance of the transparent electrode.

The present invention provides a connection structure of a display panel and a flexible printed circuit board. The connection structure includes a display panel, a flexible printed circuit board, and an anisotropic conductive film. The display panel includes a plurality of contact pads. Each of the contact pads includes a first metal layer, a first insulation layer, a second metal layer and a second insulation layer. The first insulation layer is disposed on the first metal layer, exposing a part of the first metal layer. The second metal layer is disposed on the first insulation layer. The first metal layer is electrically isolated from the second metal layer by the first insulation layer. The second metal layer is at least positioned over two lateral sides of the first metal layer. The second insulation layer is disposed on the second metal layer, exposing a part of the second metal layer and a part of the first metal layer. The flexible printed circuit board is disposed on the contact pads of the display panel. The anisotropic conductive film is disposed between the flexible printed circuit board and the contact pads. The anisotropic conductive film is in direct contact with the exposed first metal layers and second metal layers of the contact pads.

According to an embodiment of the present invention, the first metal layer of each of the contact pads is a block pattern, and the second metal layer of each of the contact pads is a frame pattern, the frame pattern covering a periphery of the block pattern.

According to an embodiment of the present invention, the first metal layer of each of the contact pads is a block pattern, and the second metal layer of each of the contact pads is a local frame pattern, the local frame pattern covering at least a periphery of the block pattern.

According to an embodiment of the present invention, the first metal layer of each of the contact pads is a block pattern, and the second metal layer of each of the contact pads is a grid pattern, the grid patter covering at least a periphery of the frame pattern.

According to an embodiment of the present invention, the display panel includes a thin film transistor (TFT) array substrate, a counter substrate, and a liquid crystal layer. The TFT array substrate includes a plurality of scan lines, a plurality of data lines, a plurality of TFTs electrically coupled with the scan lines and the data lines, a plurality of pixel structures electrically connected with the TFTs, and at least one driver IC. Each of the scan lines and each of the data lines are electrically connected with the driver IC. Each of the contact pads is electrically connected with the driver IC. The counter substrate is disposed at an opposite side of the TFT array substrate. The liquid crystal layer is disposed between the TFT array substrate and the counter substrate.

According to an embodiment of the present invention, the first metal layer, gates of the TFTs, and the scan lines are made of the same material.

According to an embodiment of the present invention, the second metal layer, sources and drains of the TFTs, and the data lines are made of the same material.

According to an embodiment of the present invention, the first insulation layer is made of silicon oxide or silicon nitride.

According to an embodiment of the present invention, the second insulation layer is made of silicon nitride or silicon oxide.

The present invention provides a specifically designed contact pad, by which even when the flexible printed circuit board is pressed with a deviation, the anisotropic conductive film can effectively contact the first metal layer and the second metal layer. As such, the present invention is adapted for decreasing the signal input variance of the two metal layers, and improving the adhesion of the flexible printed circuit board and the TFT array substrate.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a contact pad according to a conventional technology.

FIG. 2A is a schematic diagram illustrating a flexible printed circuit board being pressed upon the contact pad as shown in FIG. 1.

FIG. 2B is a schematic diagram illustrating a flexible printed circuit board being pressed with a deviation upon the contact pad as shown in FIG. 1.

FIG. 3A is a schematic diagram illustrating a connection structure of a display panel and a flexible printed circuit board according to an embodiment of the present invention.

FIG. 3B is a schematic diagram illustrating a connection structure of a display panel and a flexible printed circuit board according to another embodiment of the present invention.

FIG. 4A is a schematic diagram illustrating a flexible printed circuit board being pressed upon a contact pad according to an embodiment of the present invention.

FIG. 4B is a schematic diagram illustrating a flexible printed circuit board being abnormally pressed upon a contact pad according to an embodiment of the present invention.

FIGS. 5A through 5D are schematic diagrams illustrating pattern designs of the first metal layer and the second metal layer of the contact pad.

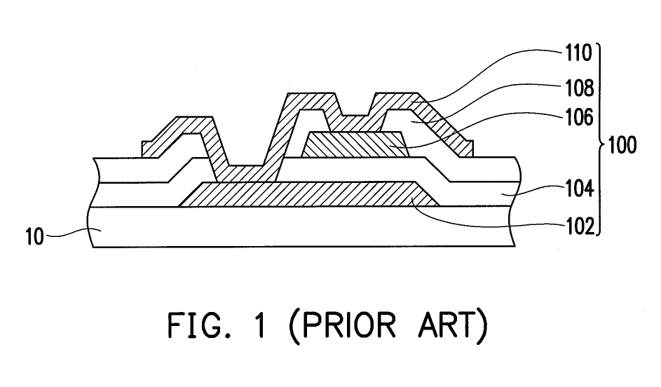

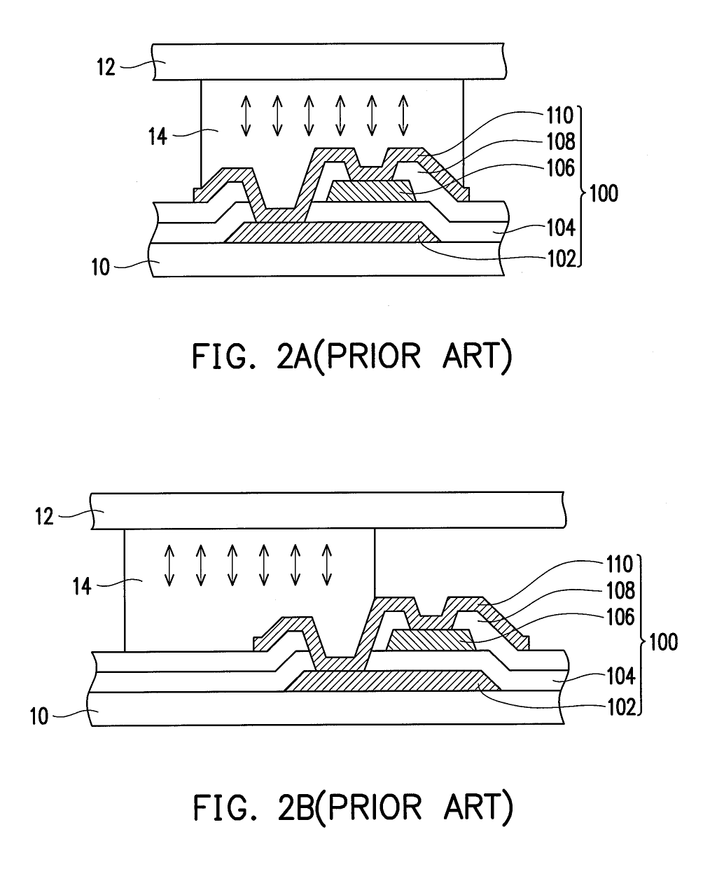

### DESCRIPTION OF THE EMBODIMENTS

Reference will now be made in detail to the present preferred embodiments of the invention, examples of which are illustrated in the accompanying drawings. Wherever possible, the same reference counting numbers are used in the drawings and the description to refer to the same or like parts.

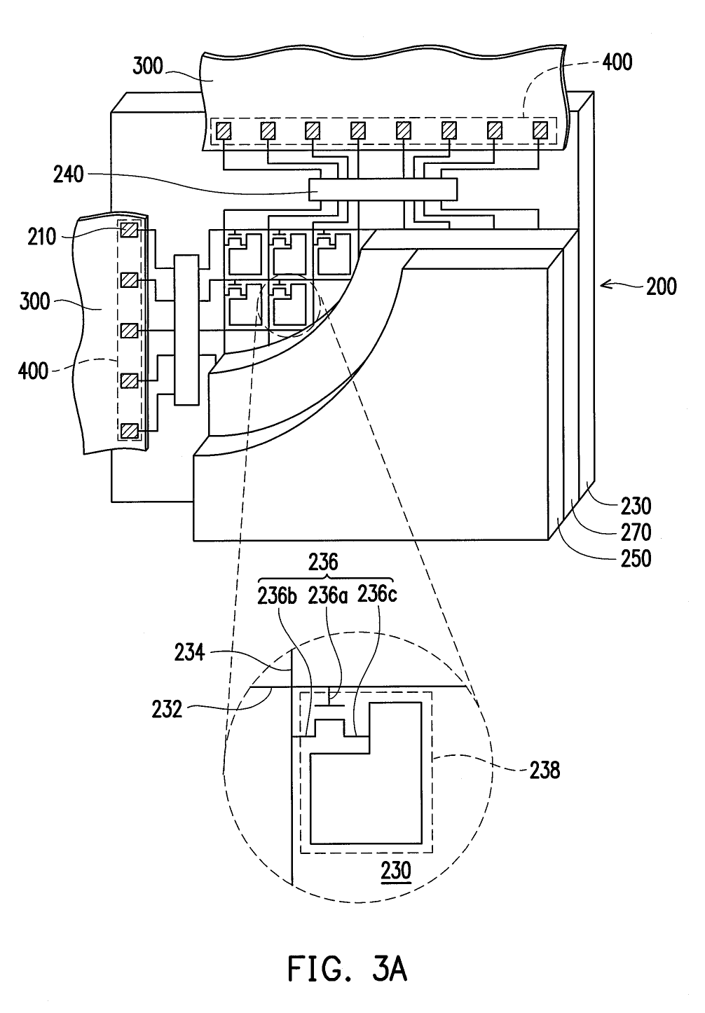

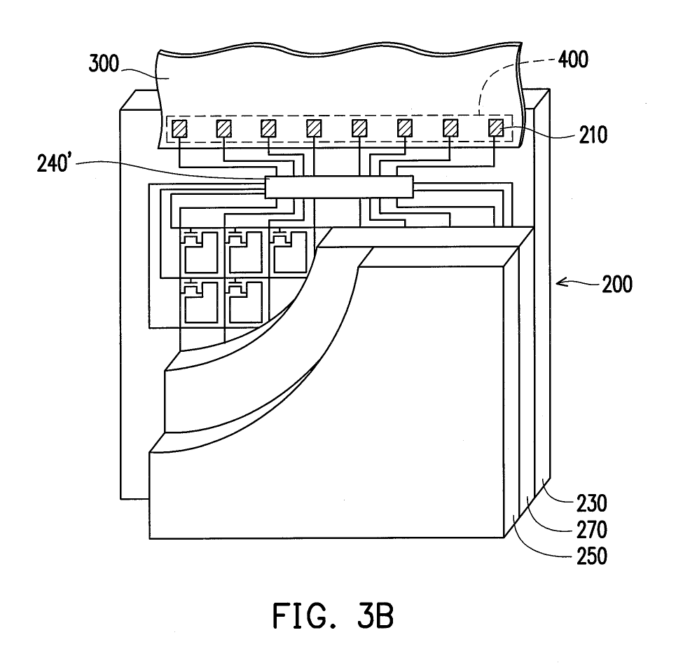

FIG. 3A is a schematic diagram illustrating a connection structure of a display panel and a flexible printed circuit board according to an embodiment of the present invention. Referring to FIG. 3A, the connection structure includes a display panel 200, a flexible printed circuit board 300, and an anisotropic conductive film 400. The display panel 200 includes a thin film transistor (TFT) array substrate 230, a counter substrate 250, and a liquid crystal layer 270. The TFT array substrate 230 includes a plurality of scan lines 232, a plurality of data lines 234, a plurality of TFTs 236 electrically connected with the scan lines 232 and the data lines 234, and a plurality of pixel structures 238 electrically connected with the TFTs 236. The display panel 200 further includes at least one driver IC 240 (two driver ICs are shown in FIG. 3A) disposed on the TFT array substrate 230. Each of the scan lines 232 and each of the data lines 234 are electrically connected to the driver ICs 240, respectively. The display panel 200 further includes a plurality of contact pads 210 electrically connected with the driver ICs 240.

Specifically, the counter substrate 250 is disposed at an opposite side of the TFT array substrate 230, and the liquid crystal layer 270 is disposed between the TFT array substrate 230 and the counter substrate 250. Each of the TFTs 236 is constituted by a gate 236a, a source 236b, and a drain 236c. Those having ordinary skill in the art should be aware of the conventional bottom gate structure or the conventional top gate structure of the TFTs 236, and the specific structure of the TFTs 236 is not to be restricted by the present invention.

Specifically, the flexible printed circuit board 300 is positioned on the contact pads of the display panel 200. The anisotropic conductive film 400 is disposed between the flexible printed circuit board 300 and the contact pads 210. It should be specified hereby that the connection structure of the display panel 200 and the flexible printed circuit board 300 is adapted for a large size panel in the current embodiment, in which the connection structure can be electrically connected with the driver ICs 240 by the scan lines 232 and the data lines 234. However, in another embodiment which includes only one driver IC 240′, as shown in FIG. 3B, each scan line 232 and each data line 234 are electrically connected with the driver IC 240′, and the contact pads 210 are electrically connected to the driver IC 240′. The connection structure of the display panel 200 and the flexible printed circuit board 300 is adapted for a small size panel.

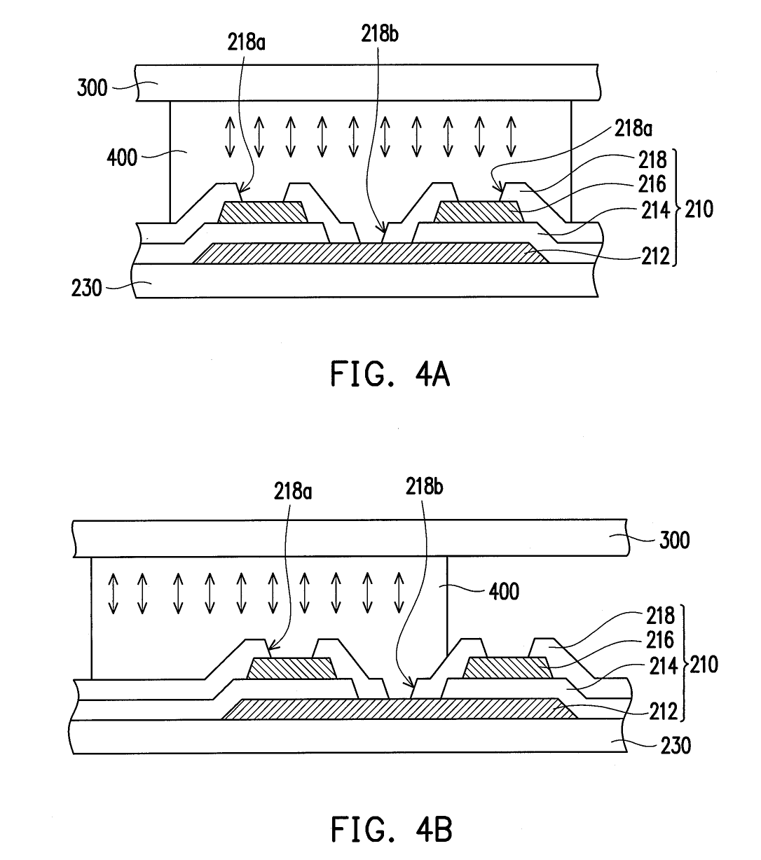

FIG. 4A is a schematic diagram illustrating a flexible printed circuit board being pressed upon a contact pad according to an embodiment of the present invention. Referring to FIGS. 3A and 4A together, each contact pad 210 includes a first metal layer 212, a first insulation layer 214, a second metal layer 216, and a second insulation layer 218. The first insulation layer 214 is disposed on the first metal layer 212, exposing a part of the first metal layer 212. The second metal layer 216 is disposed on the first insulation layer 214. The first metal layer 212 is electrically isolated from the second metal layer 216 by the first insulation layer 214. The second metal layer 216 is at least positioned over two lateral sides of the first metal layer 212. The second insulation layer 218 is disposed on the second metal layer 216, configuring at least one (two schematically shown in FIG. 4A) first contact window 218a and at least one (only one schematically shown in FIG. 4A) second contact window 218b. The first contact windows 218a expose a part of the second metal layer 216, and the second contact window 218b exposes a part of the first metal layer 212. The first insulation layer 214 for example is made of silicon oxide, silicon nitride, or other insulation materials. The second insulation layer 218 for example is made of silicon nitride, silicon oxide, or other insulation materials.

In the current embodiment, the anisotropic conductive film 400 is in direct contact with the first metal layer 212 and the second metal layer 216, and therefore the adhesion between the flexible printed circuit board 300 and the TFT array substrate 230 can be improved, and the contact resistance caused by the transparent electrode (e.g., indium tin oxide; ITO) can be decreased.

The first metal layer 212, gates 236a of the TFTs 236, and the scan lines 232 are made of the same material, while the second metal layer 216, sources 236b and drains 236c of the TFTs 236, and the data lines 234 are made of the same material, (e.g., chromium or other metal materials).

Referring to FIG. 4A again, when a press force is applied upon the flexible printed circuit board 300, the flexible printed circuit board 300 is driven by the press force to apply a force on the anisotropic conductive film 400, the anisotropic conductive film 400 is uniformly covered on the contact pads 210. In this case, the exposed first metal layer 212 and second metal layer 216 are in direct contact with the anisotropic conductive film 400. The anisotropic conductive film 400 includes a plurality of granular particles inside the anisotropic conductive film 400. When the granular particles are not being pressed to contact one to another, they present an electrical insulation characteristic. However, when the anisotropic conductive film 400 is applied with an external force, the granular particles are pressed to get in contact, so as to raise an electric conductivity. In such a way, an input signal can be uniformly transmitted from the flexible printed circuit board 300 via the granular particles to the first metal layer 212 and the second metal layer 216, and finally into the driver IC.

FIG. 4B is a schematic diagram illustrating a flexible printed circuit board being abnormally pressed upon a contact pad according to an embodiment of the present invention. Referring to FIG. 4B, when the flexible printed circuit board 300 is pressed with a deviation, the anisotropic conductive film 400 can cover only a part of the contact pads 210. However, in this case, the anisotropic conductive film 400 can still get in contact with the second metal layer 216 and the first metal layer 212 exposed by the first contact windows 218a and the second contact window 218b. As such, even when the flexible printed circuit board 300 is pressed with a deviation, because the second metal layer 216 is positioned over the two lateral sides of the first metal layer 212, the flexible printed circuit board 300 is still allowed to transmit the input signal via the anisotropic conductive film 400 to the first metal layer 212 and the second metal layer 216, and finally into the driver IC.

As discussed above, the second metal layer 216 is disposed over the two lateral sides of the first metal layer 212, so that the anisotropic conductive film 400 is capable of uniformly covering on the first metal layer 212 and the second metal layer 216 under any condition, and therefore the input signal of the flexible printed circuit board 300 can be transmitted to the first metal layer 212 and the second metal layer 216. According to the present invention, the first metal layer 212 and the second metal layer 216 can be designed with different structures to achieve the foregoing embodiments. Four different structural patterns are to be exemplified for illustrating the structures of the first metal layer 212 and the second metal layer 216 hereafter.

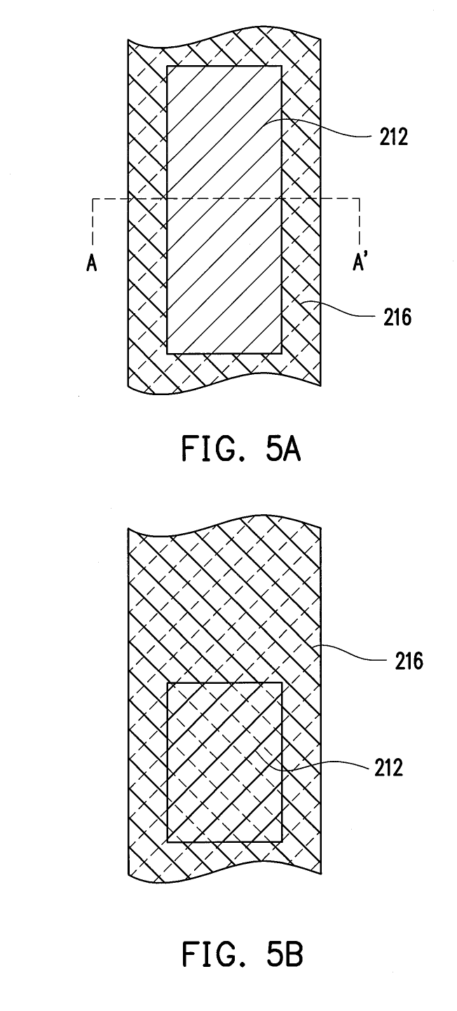

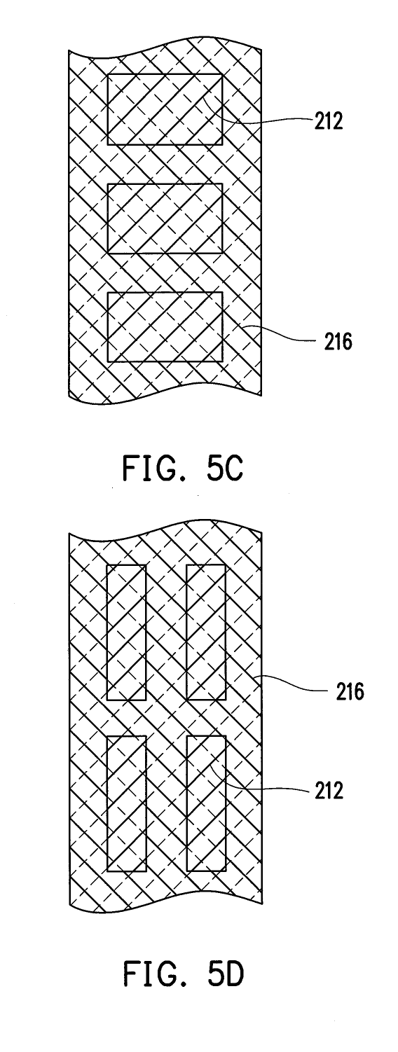

FIGS. 5A through 5D are schematic diagrams illustrating pattern designs of the first metal layer and the second metal layer of the contact pad. Referring to FIG. 5A, the first meal layer 212 of the contact pad 210 for example is a block pattern, and the second metal layer 216 of the contact pad 210 for example is a frame pattern, the frame pattern covering a periphery of the block pattern. In fact, FIG. 4A is a cross-sectional view of the first metal layer 212 and the second metal layer 216 along line A-A′ of FIG. 5A.

Further, according to another embodiment of the present invention, as shown in FIG. 5B, the first meal layer 212 of the contact pad 210 for example is a block pattern, while the second metal layer 216 of the contact pad 210 for example is a local frame pattern, the local frame pattern covering at least a periphery of the block pattern. According to a further embodiment of the present invention, as shown in FIGS. 5C and 5D, the first metal layer 212 of the contact pad 210 is a block pattern, and the second metal layer 216 of the contact pad 210 is a grid pattern, the grid patter covering at least a periphery of the frame pattern.

Specifically, according to the current embodiment, the structure of the first metal layer 212 and the second metal layer 216 is specifically designed for improving the anisotropic conductive film 400, so that the anisotropic conductive film 400 is capable of uniformly covering on the first metal layer 212 and the second metal layer 216 under any condition. As such, the present invention is adapted for decreasing the signal input variance caused by the deviation when pressing the flexible printed circuit board.

In summary, the connection structure of the display panel and the flexible printed circuit board has at least the following features and advantages:

(1) With the specifically designed contact pads, when the flexible printed circuit board is pressed with a deviation, the anisotropic conductive film can effectively get in contact the first metal layer and the second metal layer, so as to decrease an input signal variance of the two metal layers.

(2) With the specifically designed contact pads, the anisotropic conductive film is allowed to get in direct contact with the first metal layer and the second metal layer, and therefore the adhesion between the flexible printed circuit board and the TFT array substrate can be improved, and the contact resistance caused by the transparent electrode (e.g., indium tin oxide; ITO) can be decreased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A connection structure of a display panel and a flexible printed circuit board, comprising:
a display panel, comprising a plurality of contact pads, each of the contact pads comprising:
a first metal layer;
a first insulation layer, disposed on the first metal layer, exposing a part of the first metal layer;
a second metal layer, disposed on the first insulation layer, the first metal layer being electrically isolated from the second metal layer by the first insulation layer, wherein the second metal layer is at least positioned over two lateral sides of the first metal layer; and
a second insulation layer, disposed on the second metal layer, exposing a part of the second metal layer and a part of the first metal layer; and
a flexible printed circuit board, disposed on the contact pads of the display panel; and
an anisotropic conductive film, disposed between the flexible printed circuit board and the contact pads, wherein the anisotropic conductive film is in direct contact with the exposed first metal layers and second metal layers of the contact pads.

2. The connection structure according to claim 1, wherein the first metal layer of each of the contact pads is a block pattern, and the second metal layer of each of the contact pads is a frame pattern, the frame pattern covering a periphery of the block pattern.

3. The connection structure according to claim 1, wherein the first metal layer of each of the contact pads is a block pattern, and the second metal layer of each of the contact pads is a local frame pattern, the local frame pattern covering at least a periphery of the block pattern.

4. The connection structure according to claim 1, wherein the first metal layer of each of the contact pads is a block pattern, and the second metal layer of each of the contact pads is a grid pattern, the grid patter covering at least a periphery of the frame pattern.

5. The connection structure according to claim 1, wherein the display panel comprises:
a thin film transistor (TFT) array substrate comprising a plurality of scan lines, a plurality of data lines, a plurality of TFTs electrically coupled with the scan lines and the data lines, a plurality of pixel structures electrically connected with the TFTs, and at least one driver IC, wherein each of the scan lines and each of the data lines are electrically connected with the driver IC, and the contact pads are electrically connected with the driver IC;
a counter substrate, disposed at an opposite side of the TFT array substrate; and
a liquid crystal layer, disposed between the TFT array substrate and the counter substrate.

6. The connection structure according to claim 5, wherein the first metal layer, gates of the TFTs, and the scan lines are made of the same material.

7. The connection structure according to claim 6, wherein the second metal layer, sources and drains of the TFTs, and the data lines are made of the same material.

8. The connection structure according to claim 1, wherein the first insulation layer is made of silicon oxide or silicon nitride.

9. The connection structure according to claim 1, wherein he second insulation layer is made of silicon nitride or silicon oxide.
